(19) United States
(12) Patent Application Publication
(10) Pub. No.: US 2003/0040951 A1
(43) Pub. Date: Feb. 27, 2003

(54) System and method for booking work assignments

(76) Inventors: Johannes Marinus Stavleu, Alphen Aan Den Rijn (NL); Marc Roger De Jong, Lemmer (NL); Franciscus Augustinus Maria Van Der Reep, Rotterdam (NL)

Correspondence Address: MICHAELSON AND WALLACE, PARKWAY 109 OFFICE CENTER, 328 NEWMAN SPRINGS RD, P O BOX 8489, RED BANK, NJ, 07701

(21) Appl. No.: 10/200,816

(22) Filed: Jul. 22, 2002

Related U.S. Application Data
(60) Provisional application No. 60/308,988, filed on Jul. 31, 2001.

(30) Foreign Application Priority Data
Nov. 13, 2001 (EP) 01204326.1

(51) Int. Cl. G06F 17/60

(52) U.S. Cl. 705/9

(57) ABSTRACT

A system and method is provided for booking work for allocating work assignments to a worker.

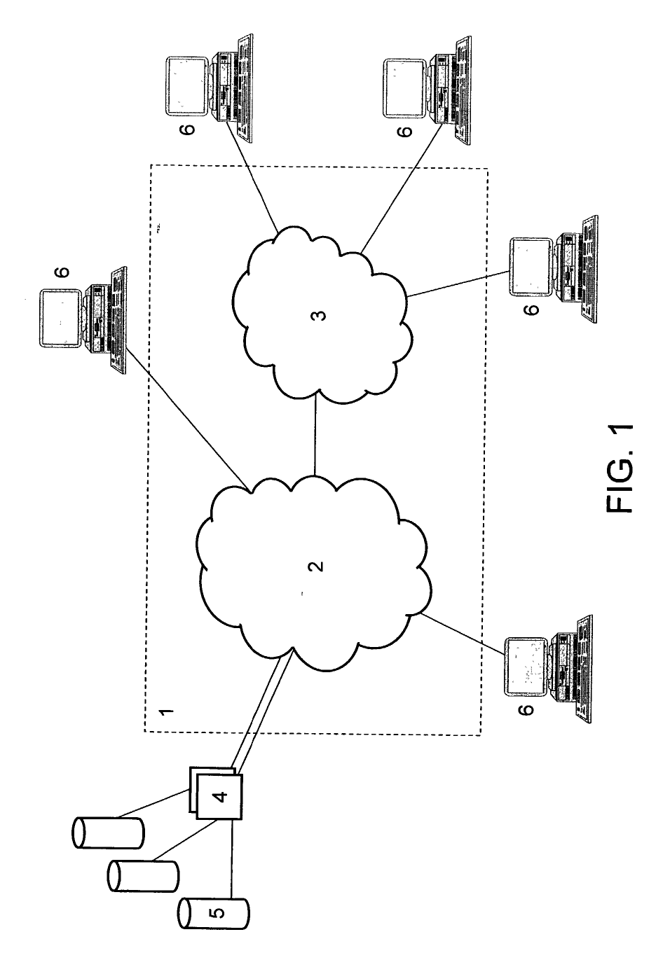

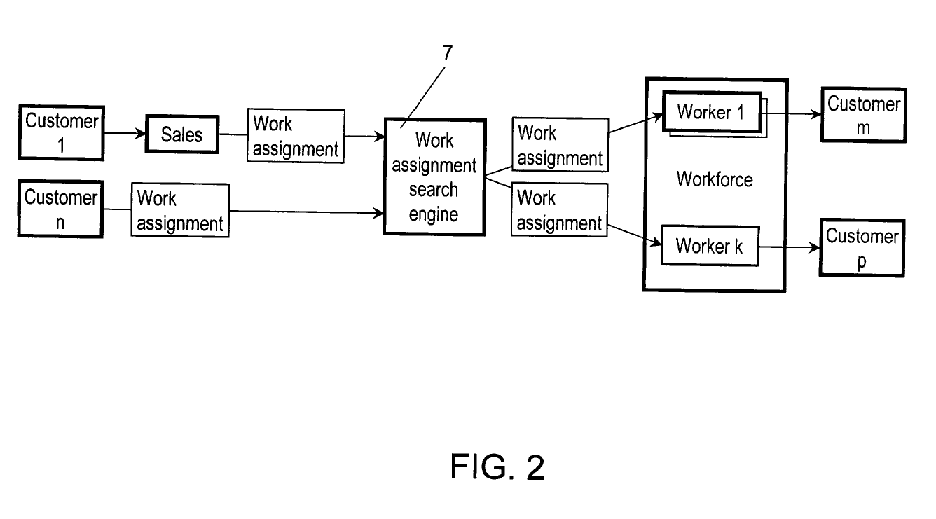

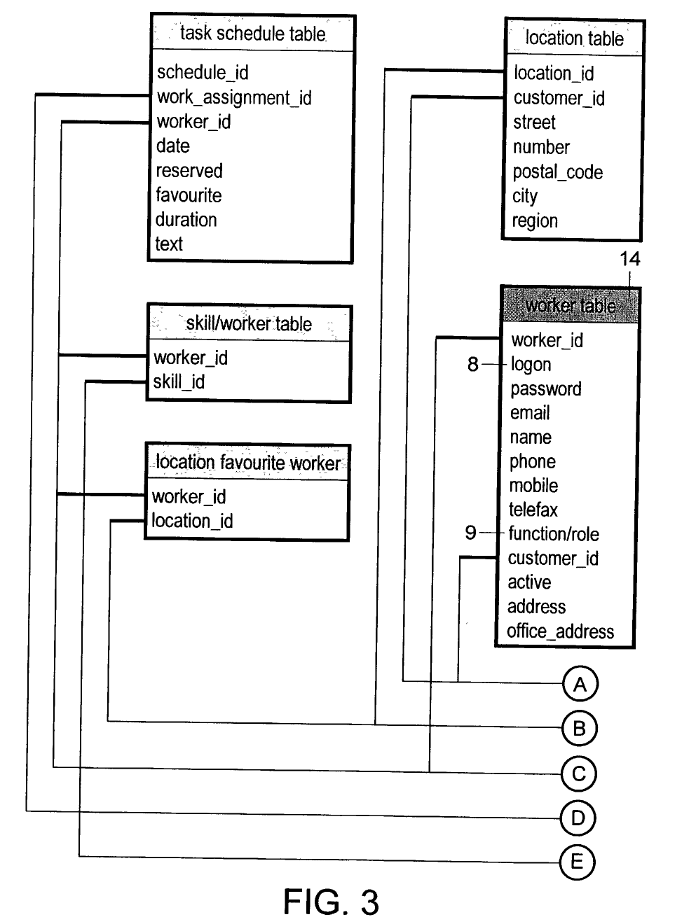

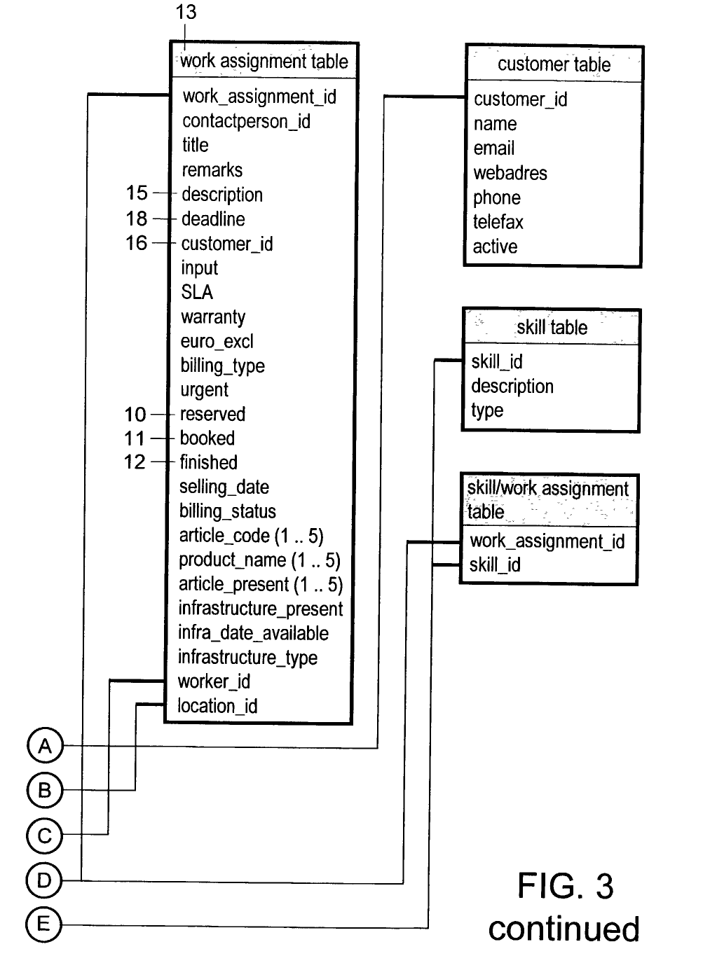

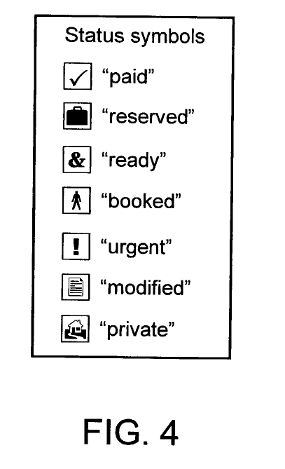

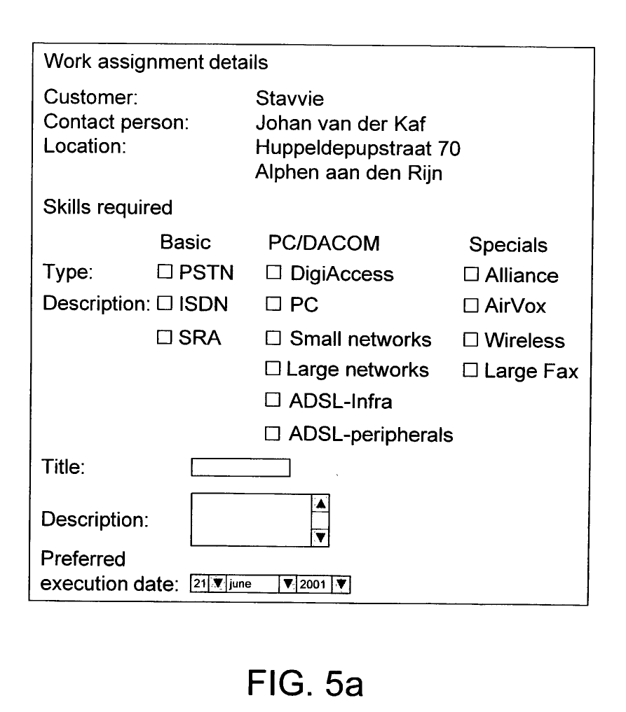

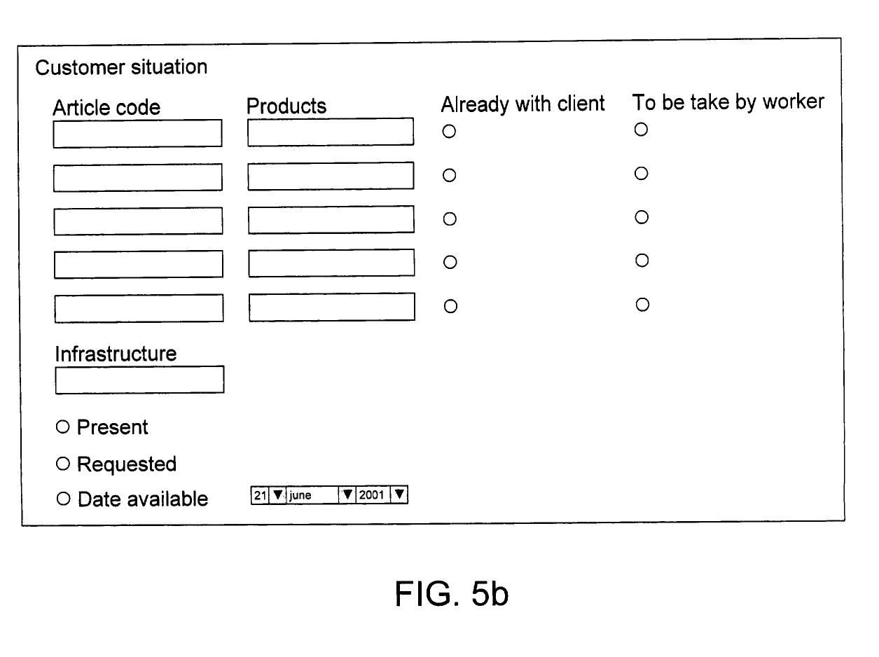

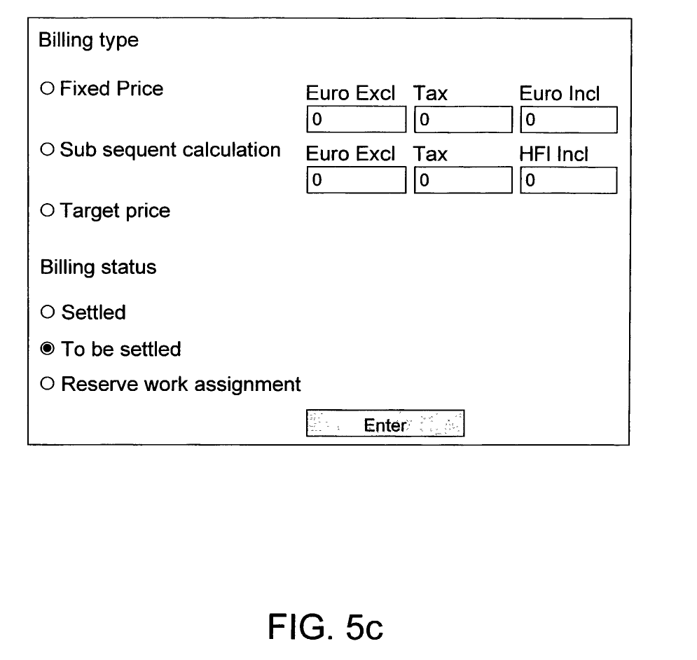

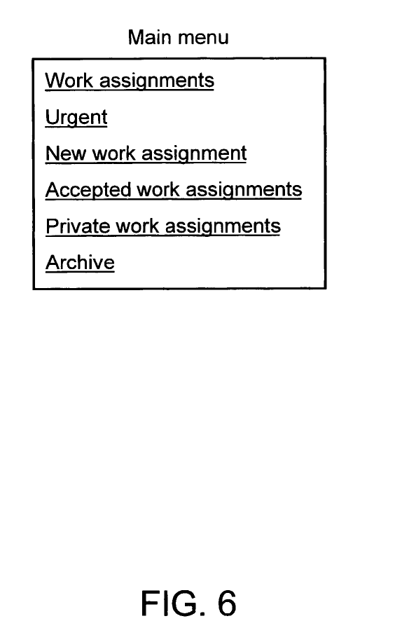

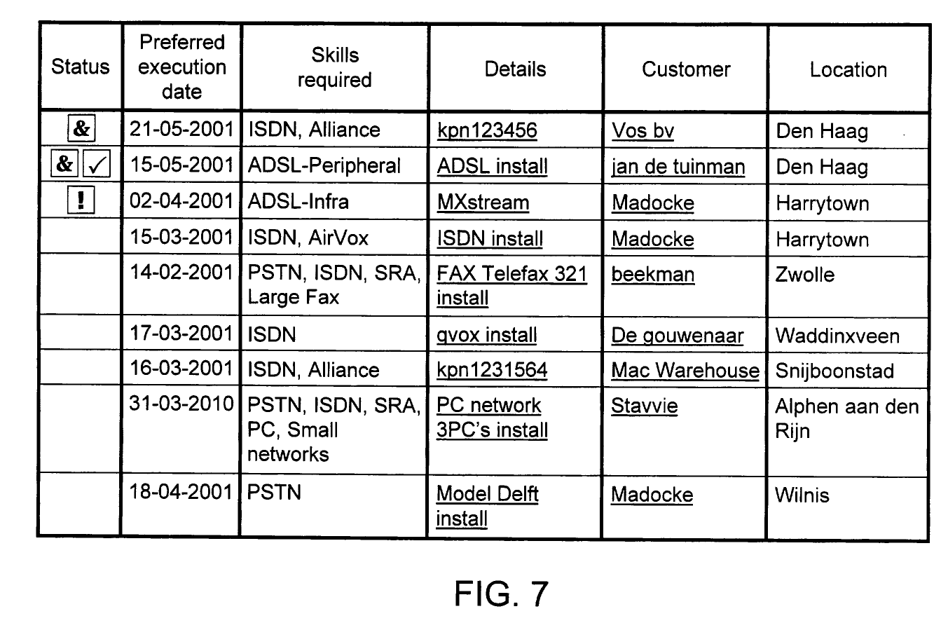

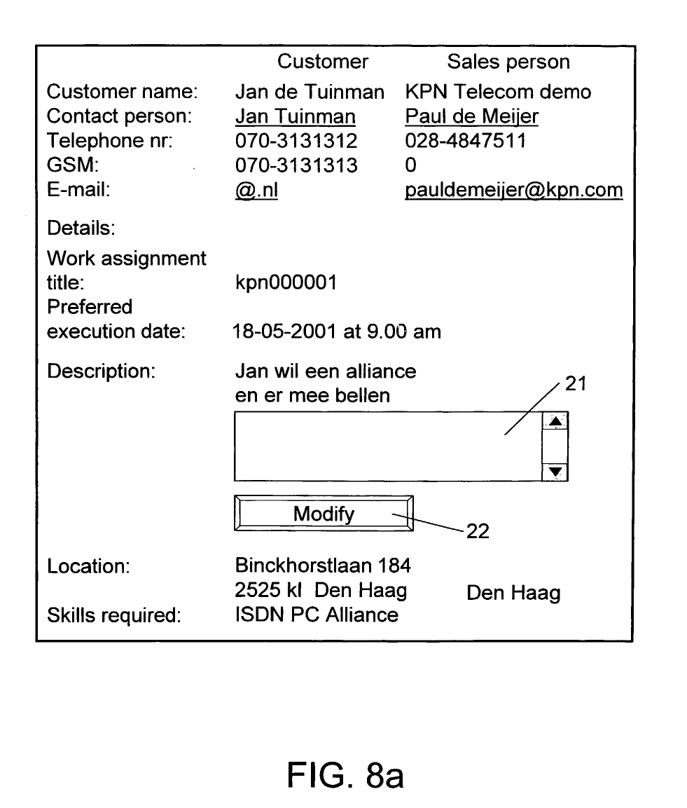

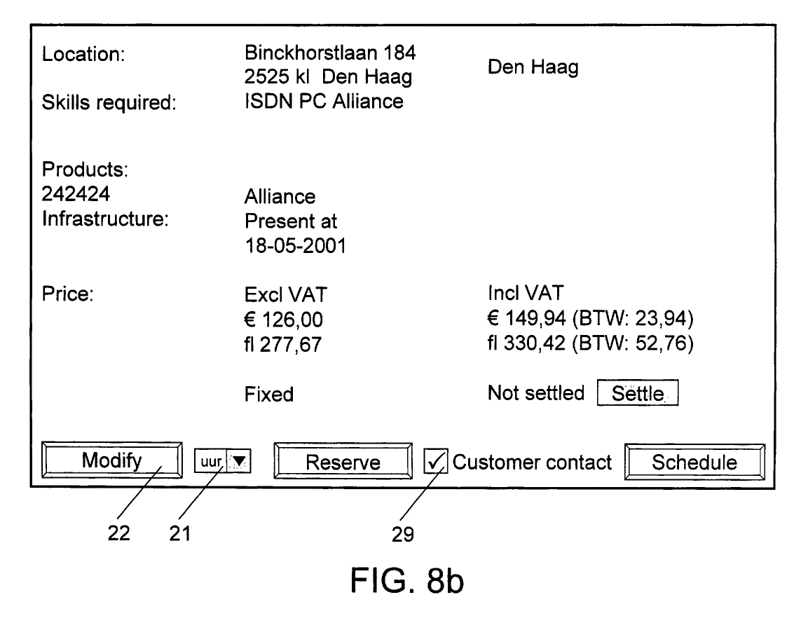

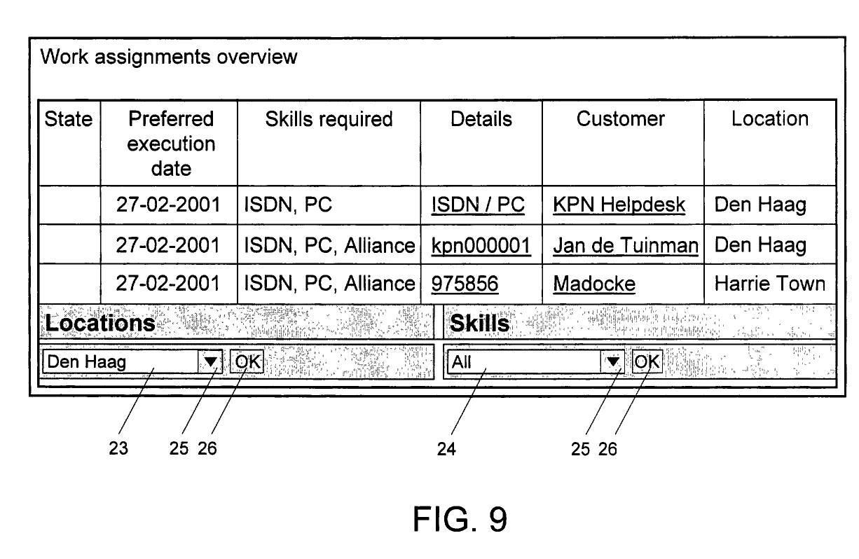

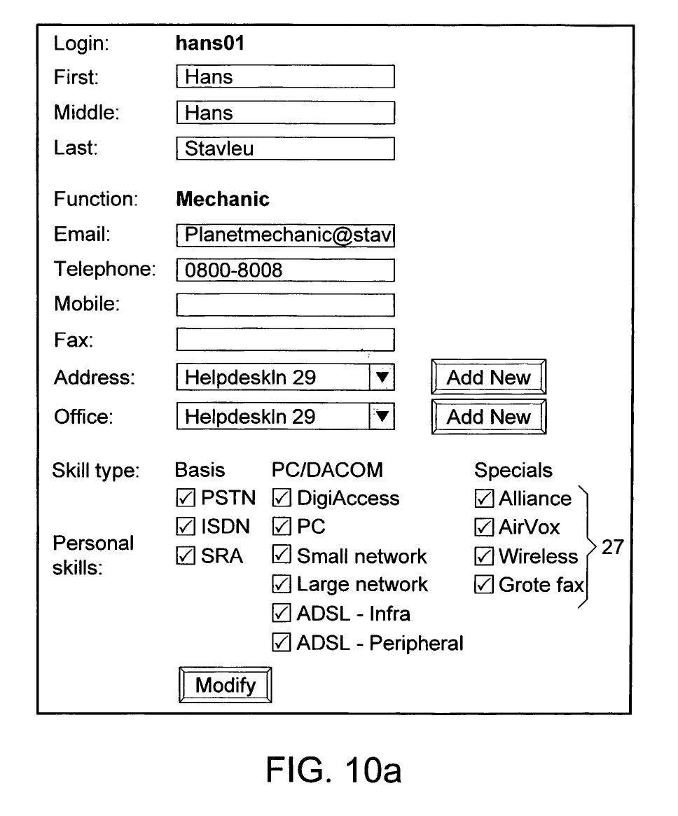

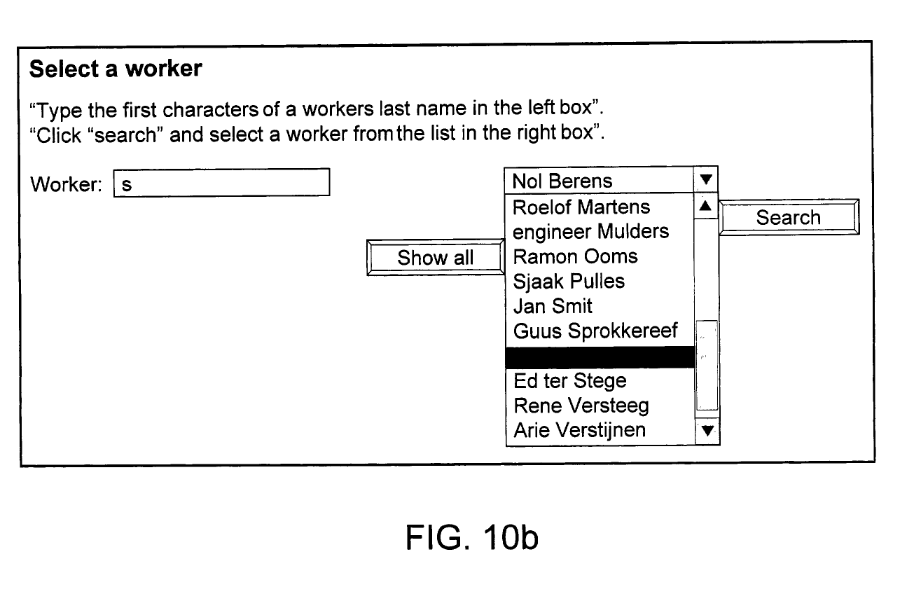

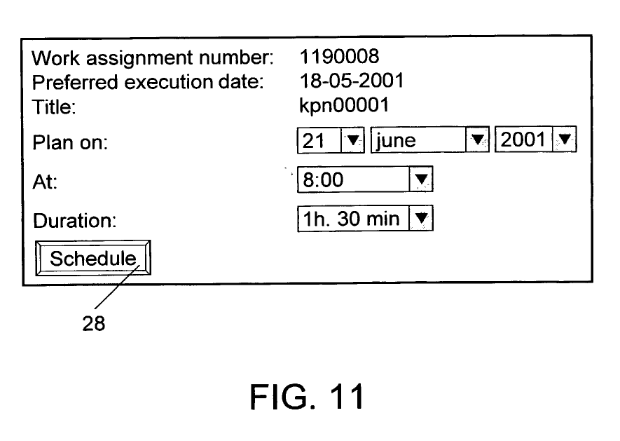

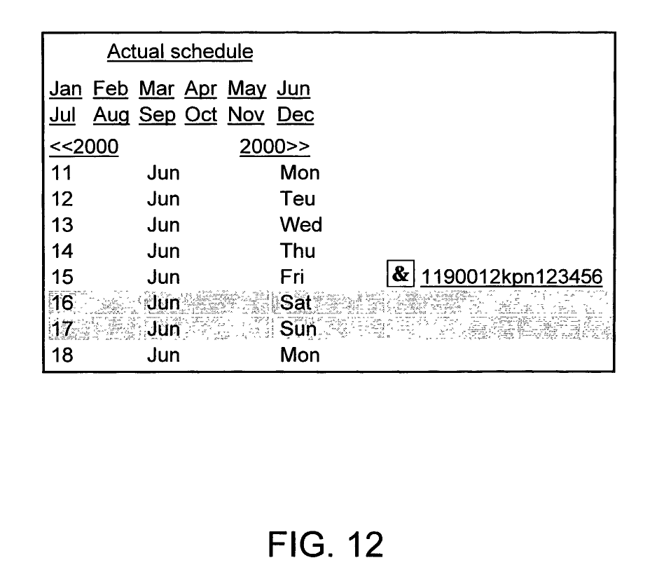

In known systems and methods work assignments are scheduled for the workers automatically. Workers cannot pick work assignments themselves.

According an aspect of the invention workers may via a worker interface select work assignments using a search engine from a work assignments pool that are free or are already booked by themselves and book and schedule them into their own schedule.

Further embodiments are described wherein the selection of work assignments is improved by providing means to select according to a worker profile, e.g. geographical region or skill level.

### CLAIM TO PRIORITY

This application claims the benefit of our co-pending United States provisional patent application entitled “Chain Reversal” filed Jul. 31, 2001 and assigned Ser. No. 60/308,988, which is incorporated by reference herein.

### FIELD OF THE INVENTION

The present invention relates to the field of software development for supporting business functions.

### BACKGROUND OF THE INVENTION

Service oriented organisations having work assignments must assign these work assignments to workers who may work in the same or in different locations. Work assignments can include service or maintenance jobs for energy or telecom companies, medical treatment in hospitals or health care centres, interviews with clients in social care, and similar environments and other areas of industry, consultancy or care.

From the state of the art it is known that there are systems which allocate work assignments to workers in such a manner that electronic means, i.e. by mobile telephone and computer notify the workers notified of their work assignments schedule for a particular period in time.

Customers, sales persons, planning managers or others place work assignments directly into a work assignment booking system. The work assignment booking system then distributes and schedules the work assignments into the workers schedules.

An example of such a system is described in patent publication WO0063819.

This publication describes how work assignments are received in the described system, examined, placed in queues and scheduled into workers schedules for a mobile. The system takes job requirements and location into account when allocating the work assignments to the workers.

1. A system for booking work assignments comprising
at least one user terminal (6) to provide a worker interface to log a worker on to the system with a logon identity (8),
a work assignment database (5) accessible via the worker interface, comprising a work assignment table (13), which comprises at least a field indicating booking status, which comprises at least a value indicating a booked status and a field indicating the logon identity (8) of the worker who marked the work assignment as booked,
said system further being arranged to provide a logged on worker via the worker interface a function for marking a work assignment record as booked.

2. The system of claim 1 further comprising at least one database server (4) connected to a network and wherein the user terminal (6) is arranged to communicate with the network (1), and wherein a work assignment database is stored in said at least one database server (4) connected to the network and wherein the database server (4) is being arranged to provide a logged worker via the worker interface a search engine (7) to give access to a set of work assignment records which are a combination of records that are not booked and records that are booked by the logged on worker, and a function for marking a work assignment record as booked.

3. The system of claim 1 and 2, wherein the worker interface comprises a set of inter linked database forms which are web accessible via hyperlinks and where one hyperlink gives a first access to a worker.

4. The system of claims 1-2 and 3, comprising a workers profiles table stored in said work assignment database (5) wherein a workers profile is identifiable with a workers logon identity (8).

5. The system of claim 2 and 3, wherein work assignment records and workers profile records comprise at least one corresponding matching field.

6. The system of claim 5, wherein the at least one corresponding matching field comprises a field indicating geographical region.

7. The system of claims 5-6, wherein the at least one corresponding matching field comprises a field indicating skill level.

8. The system of claims 5-7, wherein the at least one corresponding matching field comprises a field indicating customers category.

9. The system of claim 5-8, wherein the at least one corresponding matching field is of ordinal character.

10. The system of claim 9, arranged to provide a first function for selecting work assignments wherein the at least one corresponding matching field of a work assignment table record is ranked to a comparison value equal to the at least one corresponding matching field of the logged on workers profile database record.

11. The system of claim 10 , arranged to provide means to increase or decrease the comparison value.

12. The system of claims 10-11, wherein the nature of the ranking is at least one or a combination of “lower or less than”, “equal” and “greater or more than”.

13. The system of claims 5-12, wherein the matching fields are of Boolean character.

14. The system of claim 5-13, arranged to provide a second function for selecting work assignments wherein the at least one corresponding matching field of a work assignment table record is logically compared to the at least one corresponding matching field of the logged on workers profile database record.

15. The system of claim 14, arranged to provide means to logically enable matching fields.

16. The system of claims 1-15, wherein said work assignment table (13) comprises at least a field indicating a work assignment execution date and time.

17. The system of claims 1-16, wherein said comprises at least a field indicating a work assignment duration.

18. The system of claims 1-17, wherein said work assignment table (13) comprises at least a field indicating a work assignment finishing date and time.

19. The system of claim 1-18, comprising a workers schedule database stored in the at least one database server (4) connected to the network (1), wherein a workers schedule is identifiable with a workers logon identity (8).

20. The system of claim 19, arranged to provide a first function to copy work assignment start date and time into the logged on workers schedule.

21. The system of claims 19-20, arranged to provide a second function to copy work assignment execution duration into the logged on workers schedule.

22. The system of claims 19-21, arranged to provide a third function to copy work assignment finishing date and time into the logged on workers schedule.

23. The system of claim 1-22, arranged to provide a work assignment record markable as booked under a predefined condition.

24. The system of claim 23, arranged to provide at least one checkbox which when marked provides the predefined condition.

25. The system of claim 23-24, wherein the predefined condition is the availability at the date of the work assignment of at least one resource indicated in a resource schedule.

26. The system of claim 25, arranged to provide a search function for free space in the schedule of at least one resource.

27. The system of claims 25-26, wherein the resource comprises at least one of the logged on worker, a location, a tool, a toolkit, a part, a vehicle and a co-worker.

28. The system of claims 1-27, arranged to provide at least one customer interface for entering work assignments connected to the network.

29. The system of claims 1-28, providing work assignment records via the workers interface which are modifiable by a logged on worker.

30. A method for booking work assignments, comprising the following steps:
providing a worker access to a work assignment database (5) via a worker interface,
logging a worker on to the work assignment database (5),
providing a menu,
selecting work assignments records from a work assignment table where the status is free or where the status is booked and the work assignment is booked by the logged on worker,
providing a form displaying the selected work assignments from which a single work assignment record may be picked
providing a form displaying the selected single work assignment record
providing booking means on the form by which the status field of the single work assignment record may be set to a value indicating a booked status and by which the worker field of the work assignment record may be set to a value indicating the logged on worker.

31. The method of claim 30, providing means to select work assignments according geographical region.

32. The method of claims 30-31, providing means to select work assignments according skill level.

33. The method of claims 30-32, providing means for booking work assignment desired date, time and duration or finishing time in a logged on workers schedule.
